(19) United States
(12) Patent Application Publication
(10) Pub. No.: US 2007/0150653 A1
(43) Pub. Date: Jun. 28, 2007

(54) Processing of cacheable streaming data

(75) Inventors: Niranjan Cooray, Folsom, CA (US); Jack Doweck, Haifa (IL); Mark Buxton, Chandler, AZ (US); Varghese George, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/315,853

(22) Filed: Dec. 22, 2005

(51) Int. Cl. G06F 12/00

(52) U.S. Cl. 711/118

(57) ABSTRACT

According to one embodiment of the invention, a method is disclosed for receiving a request for cacheable memory type data in a cache-controller in communication with a first cache memory; obtaining the requested data from a first memory device in communication with the first cache memory if the requested data does not resides in at least one of the cache-controller and the first cache memory; allocating a data storage buffer in the cache-controller for storage of the obtained data; and setting the allocated data storage buffer to a streaming data mode if the obtained data is a streaming data to prevent an unrestricted placement of the obtained streaming data into the first cache memory.

### FIELD

Embodiments of the invention relates to data processing, and more particularly to the processing of streaming data.

### BACKGROUND

Media adapters connected to the input/output space in a computer system generate isochronous traffic, such as streaming data generated by real-time voice and video inputs, that results in high-bandwidth direct memory access (DMA) writes to main memory. Because the snoop response in modern processors can be unbounded, and because of the requirements for streaming data traffic, systems are often forced to use an uncacheable memory type for these transactions to avoid snoops to the processor. Such snoops to the processor, however, can adversely interfere with the processing capabilities of a processor.

Since streaming data is usually non-temporal in nature, it has traditionally been undesirable to use cacheable memory for such operations, as this will create unnecessary cache pollution. In addition, non-temporal streaming data are usually read-only once and so are not used at a future time during the data processing, thus making their unrestricted storage in a cache an inefficient use of a system's cache resources. An alternative approach has been to process the streaming data by using the uncacheable memory type. This approach, however, is not without shortcomings as it results in low processing bandwidth and high latency. The effective throughput of the streaming data is limited by the processor, and is likely to become a limiting factor in the ability of future systems to deal with high-bandwidth streaming data processing.

Increasing the bandwidth and lowering the latency associated with processing of streaming data, while still reducing the occurrence of cache pollution, would greatly benefit the throughput of high-bandwidth, streaming data in a processor.

### BRIEF DESCRIPTION OF THE DRAWINGS

FIG. 1 is a block diagram of a computer system in which embodiments of the invention can be practiced.

FIG. 2 illustrates a block diagram of a processor subsystem in which embodiments of the invention can be practiced.

FIGS. 3-5 are flow charts illustrating processes according to exemplary embodiments of the invention.

### DETAILED DESCRIPTION

Embodiments of the invention generally relate to a system and method for processing of cacheable streaming data. Herein, the embodiments of the invention may be applicable to caches used in a variety of computing devices, which are generally considered stationary or portable electronic devices. Examples of computing devices include, but not limited or restricted to the following: computers, workstations. For instance, the computing device may be generally considered any type of stationary or portable electronic device such as a set-top box, wireless telephone, digital video recorder (DVRs), networking equipment (e.g., routers, servers, etc.) and the like.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. Some embodiments of the invention are implemented in a machine-accessible medium. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.), etc.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring embodiments of the invention.

Also in the following description are certain terminologies used to describe features of the various embodiments of the invention. For example, the term “data storage buffer” refers to one or more line fill buffers of a cache-controller in which obtained data are temporary stored en-route to a cache memory, a register set or other memory devices. The term “processor core” refers to portion of a processing unit that is the computing engine and can fetch arbitrary instructions and perform operations required by them, including add, subtract, multiply, and divide numbers, compare numbers, do logical operations, load data, branch to a new location in the program etc. The term “streaming data” refers to isochronous traffic, such as streaming data generated by real-time voice and video inputs that are usually read-only once and so are not used at a future time during the data processing. The term “software” generally denotes executable code such as an operating system, an application, an applet, a routine or even one or more instructions. The software may be stored in any type of memory, namely suitable storage medium such as a programmable electronic circuit, a semiconductor memory device, a volatile memory (e.g., random access memory, etc.), a non-volatile memory (e.g., read-only memory, flash memory, etc.), a floppy diskette, an optical disk (e.g., compact disk or digital versatile disc “DVD”), a hard drive disk, or tape.

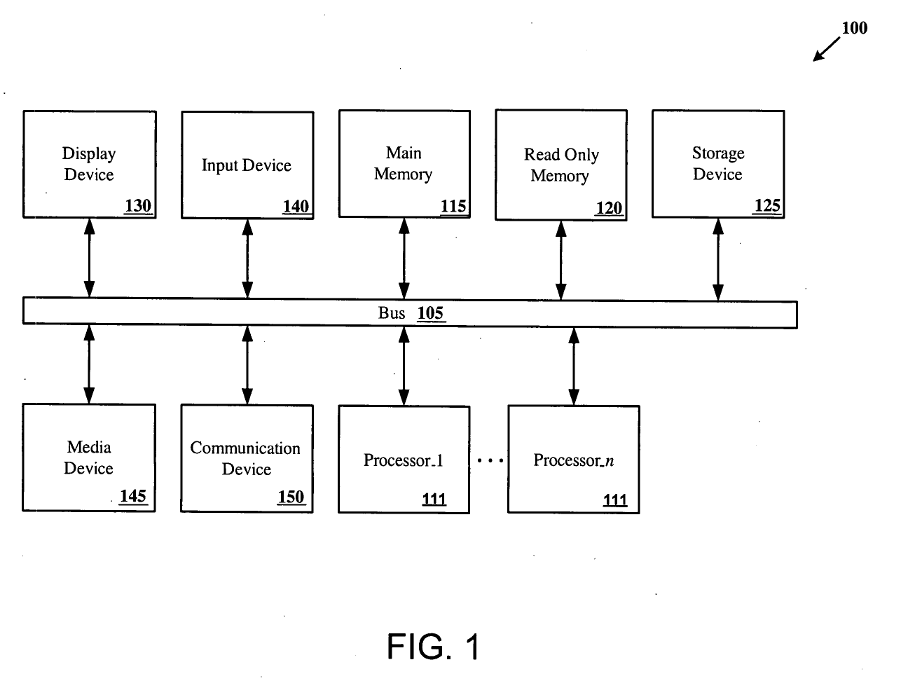

With reference to FIG. 1, an embodiment of an exemplary computer environment is illustrated. In an exemplary embodiment of the invention, a computing device 100, such as a personal computer, comprises a bus 105 or other communication means for communicating information, and a processing means such as one or more processors 111 shown as processors_1 through processor_n (n>1) coupled with the first bus 105 for processing information.

The computing device 100 further comprises a main memory 115, such as random access memory (RAM) or other dynamic storage device as for storing information and instructions to be executed by the processors 111. Main memory 115 also may be used for storing temporary variables or other intermediate information during execution of instructions by the processors 111. The computing device 100 also may comprise a read only memory (ROM) 120 and/or other static storage device for storing static information and instructions for the processors 111.

A data storage device 125 may also be coupled to the bus 105 of the computing device 100 for storing information and instructions. The data storage device 125 may include a magnetic disk or optical disc and its corresponding drive, flash memory or other nonvolatile memory, or other memory device. Such elements may be combined together or may be separate components, and utilize parts of other elements of the computing device 100.

The computing device 100 may also be coupled via the bus 105 to a display device 130, such as a liquid crystal display (LCD) or other display technology, for displaying information to an end user. In some environments, the display device 130 may be a touch-screen that is also utilized as at least a part of an input device. In some environments, display device 130 may be or may include an auditory device, such as a speaker for providing auditory information. An input device 140 may be also coupled to the bus 105 for communicating information and/or command selections to the processor 111. In various implementations, input device 140 may be a keyboard, a keypad, a touch-screen and stylus, a voice-activated system, or other input device, or combinations of such devices.

Another type of device that may be included is a media device 145, such as a device utilizing video, or other high-bandwidth requirements. The media device 145 communicates with the processors 111, and may further generate its results on the display device 130. A communication device 150 may also be coupled to the bus 105. Depending upon the particular implementation, the communication device 150 may include a transceiver, a wireless modem, a network interface card, or other interface device. The computing device 100 may be linked to a network or to other devices using the communication device 150, which may include links to the Internet, a local area network, or another environment. In an embodiment of the invention, the communication device 150 may provide a link to a service provider over a network.

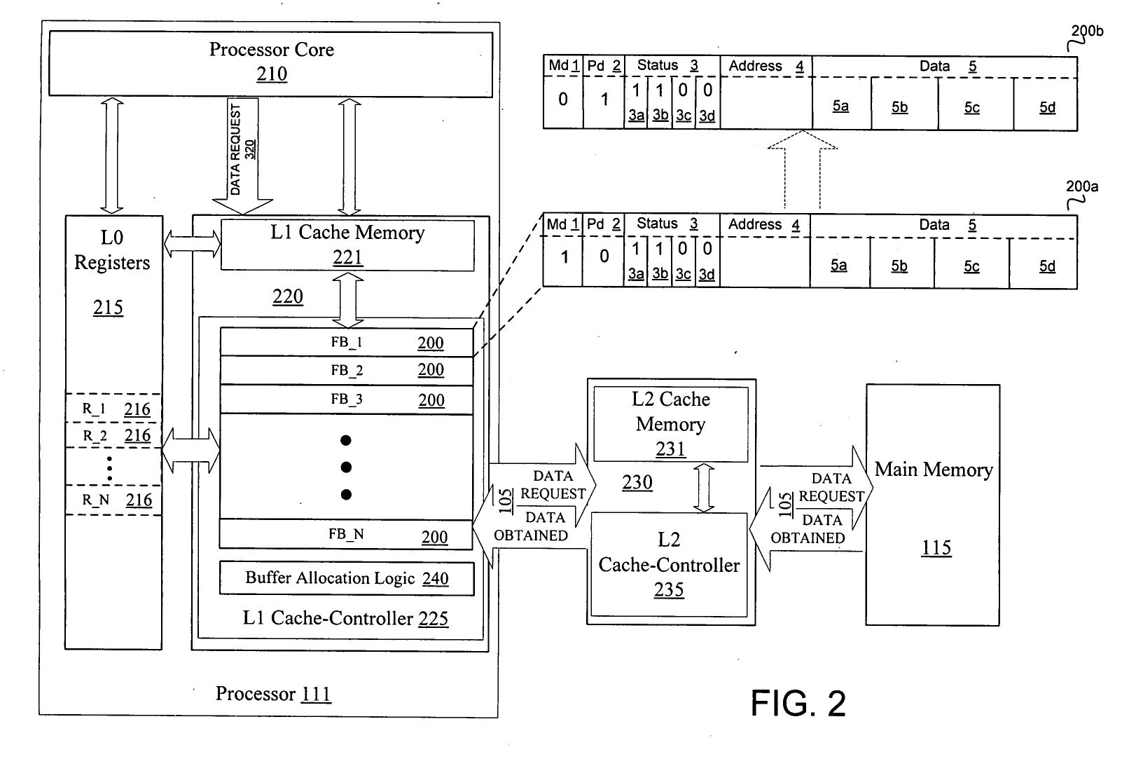

FIG. 2 illustrates an embodiment of a processor 111, such as processor_1, utilizing Level 1 (L1) cache 220, Level 2 (L2) cache 230 and main memory 115. In one embodiment, processor 111 includes a processor core 210 for processing of operations and one or more cache memories, such as cache memories 220 and 230. The cache memories 220 and 230 may be structured in various different ways depending on desired implementations.

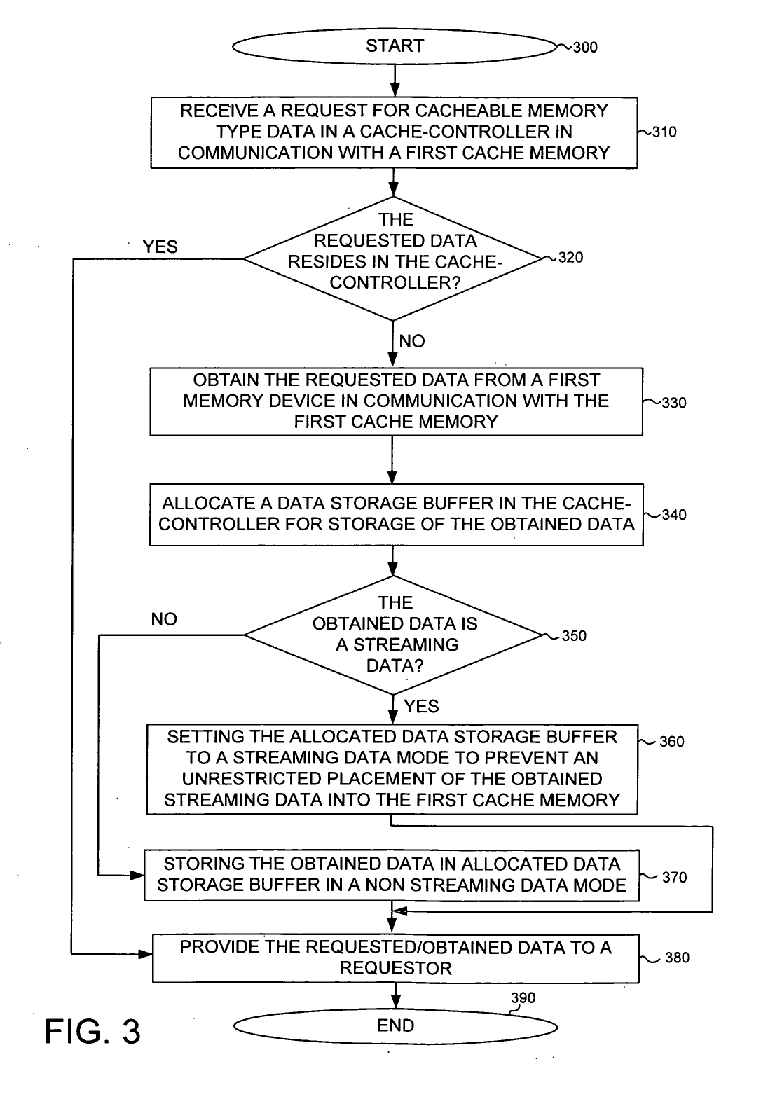

The illustration shown in FIG. 2 includes a Level 0 (L0) memory 215 that typically comprises a plurality of registers 216, such as R_1 through R_N (N>1) for storage of data for processing by the processor core 210. In communication with the processor core 210 is a L1 cache 220 to provide very fast data access. Suitably, the L1 cache 220 is implemented within the processor 111. The L1 cache 220 includes a L1 cache controller 225 which performs read/write operations to L1 cache memory 221. Also, in communication with the processor 111 is a L2 cache 230, which generally will be larger than but not as fast as the L1 cache 220. The L2 cache 230 includes a L2 cache controller 235 which performs read/write operations to L2 cache memory 231. In other exemplary embodiments of the invention, the L2 cache 230 may be separate from the processor 111. Some computer embodiments may include other cache memories (not shown) but are contemplated to be within the scope of the embodiments of the invention. Also in communication with the processor 111, suitably via L2 cache 230, are main memory 115 such as random access memory (RAM), and external data storage devices 125 such a magnetic disk or optical disc and its corresponding drive, flash memory or other nonvolatile memory, or other memory device. As described in greater detail in conjunction with FIGS. 3-5 below, embodiments of the invention allow the processor 111 to read non-temporal streaming data from one or more of L1 cache 220, L2 cache 230, main memory 240 or other external memories without polluting cache memory 221 or 231.

As shown in FIG. 2, the cache controller 225 comprises data storage buffers 200, such as FB_1 through FB_N (N>1), to provide the data in storage buffers 200, such as streaming data, to L1 cache memory 221 and or to L0 registers 215 for use by the processor core 210. Suitably, the data storage buffers 200 are cache fill line buffers. The cache controller 225 further comprises data storage buffer allocation logic 240 to allocate one or more data storage buffers 200, such as FB_1, for storage of data such as obtained streaming data, as described below and in greater detail in conjunction with FIGS. 3-5.

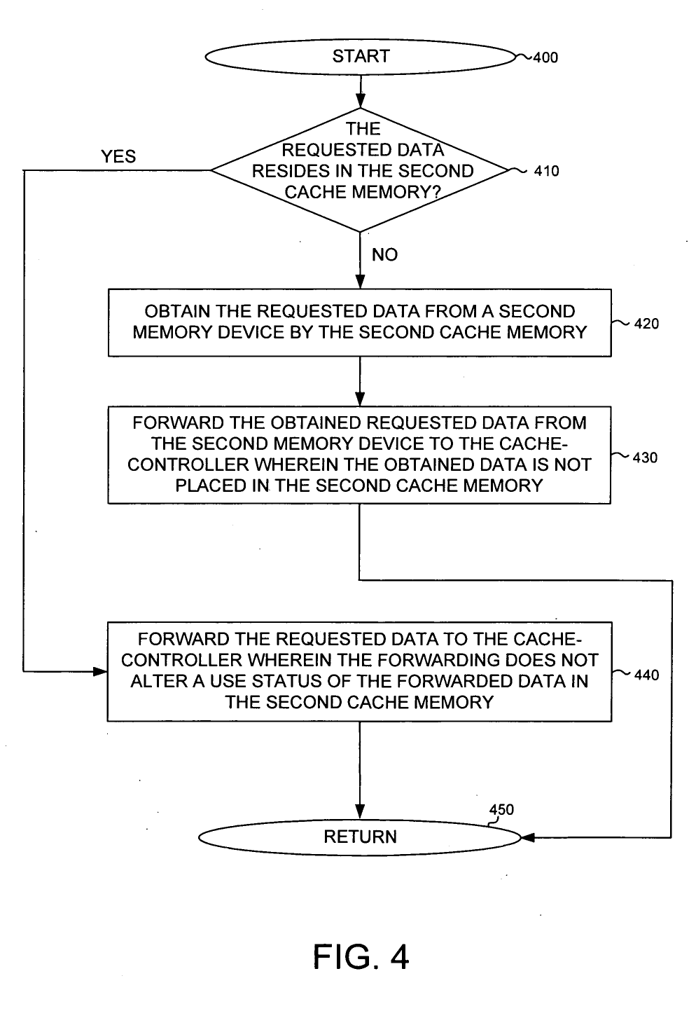

The overall series of operations of the block diagram of FIG. 2 will now be discussed in greater detail in conjunction with FIGS. 3-5. As shown in FIG. 3 the flow begins (block 300) with the receipt of a data request 320 (block 310) in the cache-controller 225 for cacheable memory type data. Next, if it is determined (decision block 320) that the requested data does not reside in either the cache-controller 225, such as in a data storage buffer 200, or the L1 cache memory 221, then the requested data is obtained from an alternate source (block 330), such as either the L2 cache 230, or the main memory 115 or external data storage devices 125 as described in greater detail in conjunction with FIG. 4 below. Next, a data storage buffer 200, such as FB-1, is allocated in the L1 cache-controller 225 for storage of the obtained data (block 340).

Next, if it is determined (decision block 350) that the obtained data is a streaming data, such as a non-temporal streaming data, then the allocated data storage buffer 200 is set to a streaming data mode (block 360) to prevent an unrestricted placement of the obtained streaming data into the L1 cache memory 221. As shown in FIG. 2, an exemplary data storage buffer 200, such as FB_1, comprises a mode designator field (Md) 1 which when set to a predetermined value, such as one, designates the data storage buffer as operating in a streaming data mode (as shown by data storage buffer 200a) for storage of non-temporal streaming data. The obtained streaming data is then provided to the requestor (block 380), such as to the processor core 210 via L0 registers 215, but with no unrestricted placement of the obtained streaming data into the L1 cache memory 22, suitably without any placement of the obtained streaming data in L1 cache memory 221. Suitably, data storage buffer 200a further comprises a placement designator (Pd) field 2 which when set to a predetermined value, such as zero, indicated that the obtained streaming data is to not be placed into the L1 cache memory 221 in an unrestricted manner, suitably to not be placed into the L1 cache memory 221 at all. Suitably, data storage buffer 200a further comprises an address storage field 4 to identify address information of the streaming data within the data storage buffer 200a.

If it is determined (decision block 350) that the obtained data is not a streaming data, then the non-streaming data is stored in the allocated data storage buffer 200 (block 370) which is in a non-streaming data mode (as shown by data storage buffer 200b). The obtained data non-streaming data is then provided to the requestor (block 380), such as to the processor core 210 via L0 registers 215 following prior art protocols and may result in the placement of the obtained non-streaming data in L1 cache memory 221.

Returning to the decision block 320, if it is determined that requested data does reside in either the cache-controller 225, such as in a data storage buffer 200, or the L1 cache memory 221, then requested data is provided to the requestor (block 380), such as to the processor core 210 via L0 registers 215. Suitably the L1 cache memory 221 is checked first for the requested data and if the requested data did not reside there, then the data storage buffers 200 are checked. If the requested data resides in the L1 cache memory 221, the requested data is provided to the requester, such as to the processor core 210, but with no updating of the status of the L1 cache memory 221, such as based on a no updating of the least recently used (LRU) lines in L1 cache memory 221 or a predetermined specific allocation policy. If the requested data resides in a data storage buffer 200, then the requested data is provided to the requester. Following the providing operations (block 380), the overall process then ends (block 390).

FIG. 4 further illustrates the process in FIG. 3 (block 330) for obtaining the requested data from an alternate source, such as from either the L2 cache 230, or the main memory 115, or external data storage devices 125. As shown in FIG. 4 the flow begins (block 400) with determining if the requested data resides in the L2 cache 230 (block 410). If the requested data resides in the L2 cache 230, the requested data is forwarded, such as via bus 105, to the L1 cache-controller 225 (block 440) wherein the forwarding does not alter a use status of the forwarded data in the L2 cache memory 231, such as no updating of the least recently used (LRU) lines in L2 cache memory 231. Suitably, the data is obtained based on a cache-line-wide request to the L1 cache-controller 225, and is written back to the processor core 210 following the forwarding. The flow is then returned (block 450) to FIG. 3 (block 330). If the requested data does not reside in the L2 cache 230 (block 410), the requested data is then obtained (block 420), such as via bus 105, from a second memory device, such as the main memory 115 or external data storage devices 125, by the L2 cache 230. The obtained data is then forwarded (block 430) to the L1 cache-controller 225 by the L2 cache-controller 235 wherein the obtained data is not placed in the L2 cache memory 231 by the L2 cache-controller 235. Suitably, the forwarded obtained data is written back to the processor core 210 following the forwarding. The flow is then returned (block 450) to FIG. 3 (block 330).

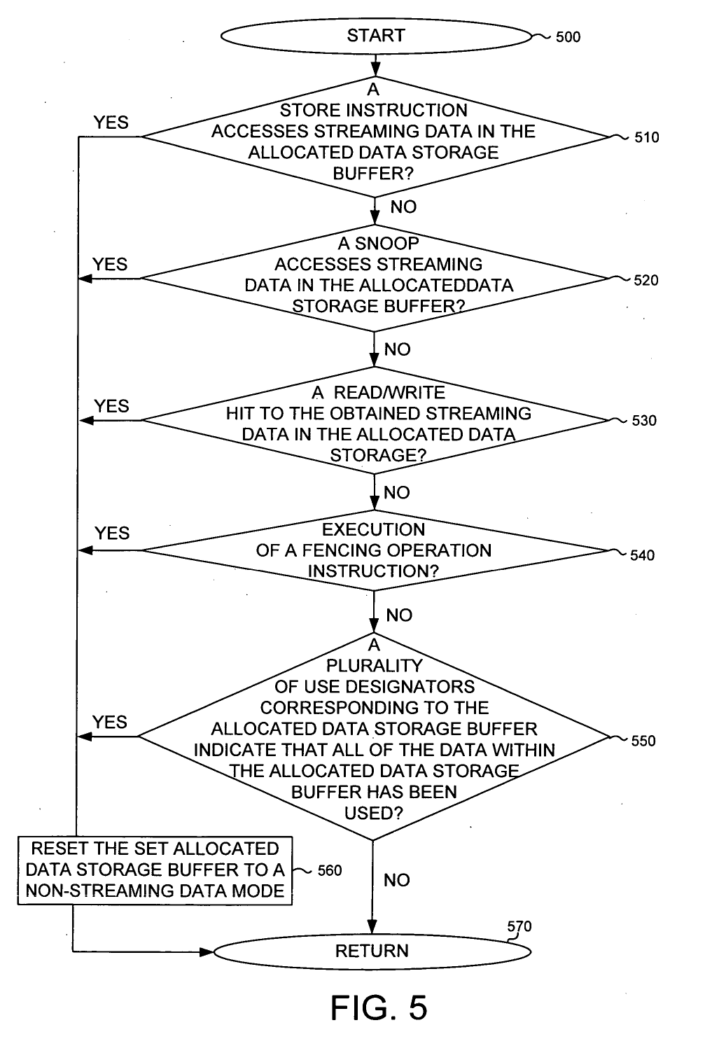

FIG. 5 further illustrates the process in FIG. 3 (block 360) for setting an allocated data storage buffer 200, such as FB_1, to a streaming data mode. As shown in FIG. 5, following the start (block 500) the set data storage buffer 200 may be reset back to a non-streaming data mode (block 560) if one or more of the following condition were to occur: 1) a store instruction accesses streaming data in the allocated data storage buffer 200 (block 510), such as during data transfers from processor core 210 to main memory 115; 2) a snoop accesses streaming data in the allocated data storage buffer 200 (block 520), such as during a processor snoop access; 3) a read/write hit (partial or full) to the obtained streaming data in the allocated data storage 200 (block 530), such as when a non-streaming cacheable load hit (when data is transferred from main memory 115 to processor core 210) occurs on the streaming data in the set data storage buffer 200; 4) execution of a fencing operation instruction, (block 540), and 5) if a plurality of use designators corresponding to the allocated data storage buffer indicate that all of the data within the allocated data storage buffer 200 has been used (block 550). Other implementation specific conditions such as no free data storage buffers 200 to allocate to a new data request may also result in the resetting of an existing streaming mode data storage buffer 200 back to a non streaming data mode.

As shown in FIG. 2, an exemplary field buffer 200a comprises a status storage field 3 to identify status and control attributes of the streaming data within the data storage buffer 200a. The status storage field 3 comprises a plurality of use designators attributes such as 3a-d wherein each of the use designators 3a-d indicates if a predetermined portion of the stored streaming data has been used. The field buffer 200 comprises a data storage field 5 for storing of the streaming data. The data storage field 5 is partitioned into predetermined data portions 5a-d wherein each of use designators attributes 3a-d correspond to a data portions 5a-d, such as use designator 3a corresponds to the data portion 5a and whose predetermined value, such as one or zero, respectively indicates if the data portion 5a has been read or not read. Suitably, the obtained data stored in the allocated data storage buffer 200a is useable (i.e. read) only once, thereafter the use designator corresponding to the read portion is set to for example one, to indicate the data portion has been already read once.

Returning to FIG. 5, if none of the conditions (blocks 510-550) occurs, then the process returns (block 570) to FIG. 3 (block 360) with the data storage buffer 200 retaining its streaming data mode, otherwise the process returns to FIG. 3 (block 360) with the data storage buffer 200 reset (i.e. transformed) to a non-streaming mode (i.e. the data storage buffer 200 is de-allocated or invalidated from its streaming data mode status). As shown in FIG. 2, the resetting will result in the mode designator field 1 of data storage buffer 200 (shown in the set mode of 200a) to be reset (shown in reset mode of 200b) to a predetermined value such as zero, to indicate the data storage buffer 200 is now operating in a non-streaming mode 200b. In addition, the placement field 2 is also suitably reset to a predetermined value such as 1, to indicate that the data in storage buffer 200 is now permitted to be placed in the L1 cache memory 221 if such action is called for.

Suitably, the software that, if executed by a computing device 100, will cause the computing device 100 to perform the above operations described in conjunction with FIGS. 3-5 is stored in a storage medium, such as main memory 115, and external data storage devices 125. Suitably, the storage medium is implemented within the processor 111 of the computing device 100.

It should be noted that the various features of the foregoing embodiments of the invention were discussed separately for clarity of description only and they can be incorporated in whole or in part into a single embodiment of the invention having all or some of these features.

What is claimed is:

1. A method comprising:
receiving a request for cacheable memory type data in a cache-controller in communication with a first cache memory;
obtaining the requested data from a first memory device in communication with the first cache memory if the requested data does not resides in at least one of the cache-controller and the first cache memory;
allocating a data storage buffer in the cache-controller for storage of the obtained data; and
setting the allocated data storage buffer to a streaming data mode if the obtained data is a streaming data to prevent an unrestricted placement of the obtained streaming data into the first cache-memory.

2. The method of claim 1, wherein the first memory device is a second cache memory and wherein the obtaining the data from the first memory device further comprising:
determining if the requested data resides in the second cache memory; and
forwarding the requested data to the cache-controller if the requested data resides in the second cache memory wherein the forwarding does not alter a use status of the forwarded data in the second cache memory.

3. The method of claim 2, further comprising:
obtaining the requested data from a second memory device by the second cache memory if the requested data does not reside in the second cache memory; and
forwarding the obtained requested data from the second memory device to the cache-controller wherein the obtained data is not placed in the second cache memory.

4. The method of claim 1, wherein the cache-controller is in communication with a processor and wherein setting the allocated data storage buffer to a streaming data mode provides the obtained data to the processor without a placement of the obtained data in the first cache memory.

5. The method of claim 1, further comprising:
providing the requested data to a requestor if the requested data resides in at least one of the cache-controller and the first cache memory.

6. The method of claim 1, wherein the obtained data stored in the allocated data storage buffer is useable only once.

7. The method of claim 1, resetting the set allocated data storage buffer to a non-streaming data mode if at least one of the following occurs:
a store instruction accesses streaming data in the allocated data storage buffer;
a snoop accesses streaming data in the allocated data storage buffer;
a read/write hit to the obtained streaming data in the allocated data storage;
a plurality of use designators corresponding to the allocated data storage buffer indicate that all of the data within the allocated data storage buffer has been used; and
execution of a fencing operation instruction.

8. The method of claim 1, wherein the obtained streaming data is a non-temporal streaming data.

9. The method of claim 1, wherein the obtained streaming data is placed into the first cache memory in a restricted format based on at least one of a least recently used (LSU) policy and a predetermined specific allocation policy.

10. The method of claim 2, wherein the first cache memory is a faster-access cache memory than the second cache memory.

11. The method of claim 1, wherein the obtained data is obtained based on a cache-line-wide request to the first memory device.

12. A system comprising:
a data storage buffer to receive cacheable memory type streaming data and to provide the streaming data to a first cache memory and a processor, the data storage buffer further comprising:
a mode designator to designate the data storage buffer as operating in a streaming data mode; and
a placement designator to prevent an unrestricted placement of the streaming data into the first cache memory.

13. The system of claim 12, further comprising:
a cache-controller subsystem comprising a plurality of data storage buffers and data storage buffer allocation logic subsystem to allocate data storage buffer for storage of streaming data.

14. The system of claim 12, further comprising:
a plurality of use designators corresponding to the allocated data storage buffer wherein each use designator indicates if a predetermined portion of the stored streaming data has been used.

15. The system of claim 12, wherein the data storage buffer further comprising:
a mode designator storage area to designate the data storage buffer as operating in a streaming data mode;
a placement designator storage area to prevent an unrestricted placement of the streaming data into the first cache memory;
a status storage area to identify status and control attributes of the streaming data within the data storage buffer;
an address storage area to identify address information of the streaming data within the data storage buffer; and
a data storage area to store the streaming data of the data storage buffer.

16. The system of claim 15, wherein the status storage area further comprising:
a plurality of use designator storage areas to indicate if a predetermined portion of the stored streaming data has been used.

17. A storage medium that provides software that, if executed by a computing device, will cause the computing device to perform the following operations:
receiving a request for cacheable memory type data in a cache-controller in communication with a first cache memory;
obtaining the requested data from a first memory device in communication with the first cache memory if the requested data does not resides in at least one of the cache-controller and the first cache memory;
allocating a data storage buffer in the cache-controller for storage of the obtained data; and
setting the allocated data storage buffer to a streaming data mode if the received data is a streaming data to prevent an unrestricted placement of the obtained streaming data into the first cache memory.

18. The storage medium of claim 18, wherein the first memory device is a second cache memory and wherein the obtaining the data from the first memory device caused by execution of the software further comprises:
determining if the requested data resides in the second cache memory; and
forwarding the requested data to the cache-controller if the requested data resides in the second cache memory wherein the forwarding does not alter a use status of the forwarded data in the second cache memory.

19. The storage medium of claim 18, wherein the operations caused by the execution of the software further comprising:
obtaining the requested data from a second memory device by the second cache memory if the requested data does not reside in the second cache memory; and
forwarding the obtained requested data from the second memory device to the cache-controller wherein the obtained data is not placed in the second cache memory.

20. The storage medium of claim 17, wherein the storage medium is implemented within a processing unit of the computing device.
